(19) United States
(12) Patent Application Publication
(10) Pub. No.: US 2012/0254173 A1
(43) Pub. Date: Oct. 4, 2012

(54) GROUPING DATA

(76) Inventor: Goetz Graefe, Madison, WI (US)

(21) Appl. No.: 13/077,137

(22) Filed: Mar. 31, 2011

(51) Int. Cl. G06F 17/30

(52) U.S. Cl. 707/737; 707/E17.089

(57) ABSTRACT

A computer-executed method for grouping data comprising, with a processor, generating a number of sorted runs from an unsorted input, storing the sorted runs in temporary storage, placing pages of data from the sorted runs, one at a time, into a portion of a buffer allocated to receive that page, and from the allocated portion of the buffer, merging each page of data, one at a time, into a number of aggregated records, the number of aggregated records also being stored in the buffer.

### BACKGROUND

Extracting information and data from large databases in the most efficient manner is an increasingly difficult task. The problem is exasperated when the user needs organized data that can be interpreted by the user in a meaningful way. Additionally, because of the large amounts of data that may need to be processed before any meaningful data may be evaluated by the user, a processor may need to access many data items, organize them, possibly join one data set with another, group data items, compute aggregate data values per group, and remove any duplicate items as efficiently as possible.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram illustrating a system for grouping data by aggregation and duplicate removal during run generation according to one example of principles described herein.

FIG. 2a is a flowchart showing a method of grouping data according to one example of the principles described herein.

FIG. 2b is a flowchart showing a method for grouping data according to another example of the principles described herein.

FIG. 3 is a flowchart describing the method of consuming runs and computing aggregation data as briefly described in FIG. 2b, according to one example of the principles described herein.

FIG. 4 is a flowchart describing the method of processing data within a single page as briefly described in FIG. 3, according to one example of the principles described herein.

FIG. 5 is a diagram depicting a number of output pages and a single input run within the buffer, according to one example of principles described herein.

Throughout the drawings, identical reference numbers designate similar, but not necessarily identical, elements.

### DETAILED DESCRIPTION

Efficient database querying has become increasingly important as the amount of data being stored has increased over time. The faster a device can process data, the faster the user may be able to access the output and make informed decisions based on that data.

Occasionally, a user of a computing system may need to group a large amount of data from a database based on a specific key value or values within the data. Grouping of data usually involves receiving an input and grouping the individual records within that data such that specific information within each of the records is aggregated, duplicate records are removed, and the output delivered to the user or saved on disk. This is done so that a user will be able to access the data with a reduced data volume, e.g., with sums or averages replacing many individual data values. Consequently, the data is then in a form that may be more readily interpreted by the user in a meaningful way.

Various devices may implement a number of algorithms based on sorting the data by using a merge sort, implementing hash partitioning, or temporarily indexing the data. These three algorithms may each be used by the computing system or device to help aggregate data and remove any duplicate records within the data.

Some computing systems implement three types of algorithms, namely an indexed based sorting algorithm, a merge sort, or hash partitioning; utilizing one of the three depending on the type of input data received. However, allowing a computer system to choose between three different algorithms to sort the incoming data may prove problematic. Specifically, the computing system may occasionally choose the wrong algorithm thereby failing to sort the data in the most efficient way and with the least amount of effort. A poor choice in algorithm may result in poor performance, dissatisfied users, and disrupted workflows in the data center.

Therefore, various examples of the principles described herein provide for a device which uses a single algorithm to efficiently aggregate data and remove any duplicate records within an input. The single algorithm serves to replace hash partitioning, indexed based sorting, and merge sort, thereby providing an algorithm that is always at least as efficient as any of these three. Additionally, with only one algorithm to choose from, the device is able to sort and group data in the most efficient way, thereby using less resources and increasing productivity.

This single algorithm directs a processor to receive an input and generate a number of sorted runs with that input. The sorted runs may then be placed on disk temporarily. These sorted runs may then be merged together to form larger and fewer runs. Once all of the input data has been sorted based on a specific and predefined key value, a single page of data from one of the number of runs is added to the buffer. Each record from that page will then be aggregated and added to a page of aggregated data records. Because of the sorted nature of the input data, the domain of possible key values may change as the buffer consumes pages from the input being temporarily stored on disk. Indeed, the buffer holds only a range of possible key values called an immediate key range. Fully aggregated records no longer falling in the immediate key range are sent as output once the processor determines that no other records exist which can be aggregated into any one specific aggregation records. Upon consumption of the single page of input data, a new single page of data is placed in the buffer and consumed as well until all pages, one by one, are consumed.

Allocating only a portion of the buffer for a single page of input allows the buffer to contain more individual aggregation records and the algorithm therefore process more runs from the temporary disk than could have been processed otherwise in a traditional merge step. Therefore, as the immediate key range progresses through the possible key values adding individual records to their respective aggregation records, it is possible to choose only those pages within the presorted runs which include records having key values falling within the immediate key range. Any records having a key value falling outside of the immediate key range have either already been sent to output or are still present in any number of pages within the presorted runs on temporary disk.

Therefore, in this manner the individual pages of sorted data stored temporarily on disk may be consumed in a relatively faster and efficient manner than would otherwise be accomplished with the above mentioned indexed based sorting algorithm, a merge sort algorithm, or hash partitioning algorithm. Specifically, the merging steps performed in these three traditional algorithms take longer to execute than the merge step of the present algorithm, thereby increasing the processing time needed and decreasing the amount of memory allocated for the merging process within the buffer.

As used in the present specification and in the appended claims, the term “data” is meant to be understood broadly as a representation of facts or instructions in a form suitable for communication, interpretation, or processing by a computing device and its associated data processing unit. Data may comprise, for example, constants, variables, arrays, and character strings. In connection with the above, as used in the present specification and in the appended claims, the terms “record” or “records” are meant to be understood broadly as a group of related data, words, or fields that are treated as a unit. One example of a record would be a collection of name, address, and telephone number for a particular party.

Additionally, as used in the present specification and in the appended claims, the term “buffer” is meant to be understood broadly as any area of memory into which data records are read and in which those records are modified and held during processing. In one example, a buffer may, at least temporarily, contain records, pages of data, runs of pages, hash tables, and indexing tables.

Still further, as used in the specification and in the appended claims the term “page” or “page of data” is meant to be understood broadly as any amount of data. In certain examples, a page of data may be an amount of data transferred from a temporary storage device such as a hard drive to buffer memory. In other examples, a page of data may be an amount of data moved up or down within the hierarchy of storage levels in a storage device. In one example, a number of pages may form a run within the memory.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

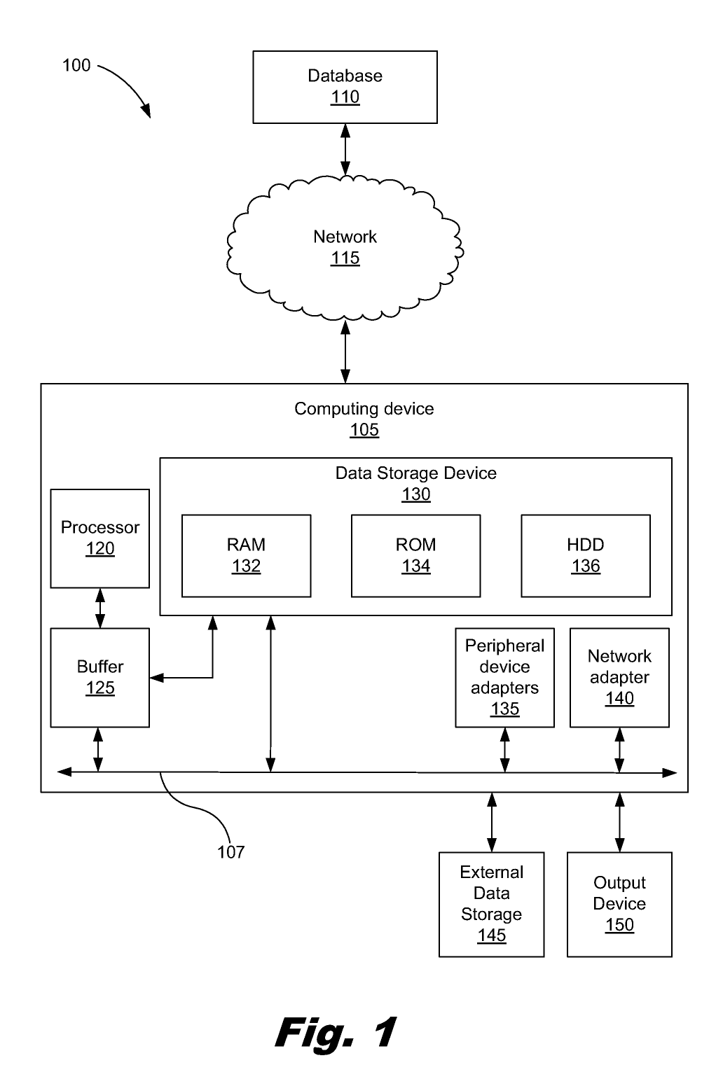

Referring now to FIG. 1, a system (100) for grouping data by aggregation and duplicate removal during run generation is shown. The system (100) may include a computing device (105) having access to a database (110). In the present example, for the purposes of simplicity in illustration, the computing device (105) and the database (110) are separate computing devices communicatively coupled to each other through a network (115).

However, the principles set forth in the present specification extend equally to any alternative configuration in which a computing device (105) incorporates or otherwise has access to the database (110). Alternative examples to that shown within the scope of the principles of the present specification include, but are not limited to, examples in which the computing device (105) and the database (110) are implemented by the same computing device, examples in which the functionality of the computing device (105) is implemented by multiple interconnected computers, for example, a server in a data center and a user's client machine, examples in which the computing device (105) and the database (110) communicate directly through a bus without intermediary network devices, and examples in which the computing device (105) has a stored local copy of the database (110) that is to be analyzed.

The computing device (105) of the present example retrieves data or records from the database (110) and aggregates the data while removing any duplicate entries within the data. In the present example, this is accomplished by the computing device (105) requesting the data or records contained within the database (110) over the network (115) using the appropriate network protocol, for example, Internet Protocol (“IP”). In another example, the computing device (105) requests data or records contained within other data storage devices such as, for example, data storage device (130) and external data storage (145).

An illustrative process for aggregation and duplicate removal of data during run generation are set forth in more detail below. To achieve its desired functionality, the computing device (105) includes various hardware components. Among these hardware components may be at least one processor (120), at least one buffer (125), at least one data storage device (130), peripheral device adapters (135), and a network adapter (140). These hardware components may be interconnected through the use of one or more busses and/or network connections. In one example, the processor (120), buffer (125), data storage device (130), peripheral device adapters (135), and network adapter (140) may be communicatively coupled via bus (107).

The processor (120) may include the hardware architecture for retrieving executable code from the data storage device (130) and executing the executable code. The executable code may, when executed by the processor (120), cause the processor (120) to implement at least the functionality of aggregating data and removing duplicate records or data among that data within a database such as database (110) or external database (145). This is done in order to present data to a user of the computing device (105) in an aggregated and grouped manner that is intelligible to the user according to the methods of the present specification described below. In the course of executing code, the processor (120) may receive input from, and provide output to, one or more of the remaining hardware units.

In one example, the computing device (105), and, specifically, the processor (120), accesses data within the database (110), aggregates that data, and presents the data to a user via an output device (150), such as a monitor or display device. The processor (120), in one example, presents data to the user through a user interface on the output device (150).

The data storage device (130) may store data that is processed and produced as output by the processor (120). As will be discussed in more detail below, the data storage device (130) may specifically save data including, for example, records. All of this data may further be stored in the form of a number of records representing the grouped data in a database for easy retrieval. The data storage (130) may include various types of memory modules, including volatile and nonvolatile memory. For example, the data storage (130) of the present example includes random access memory (RAM) (132), read only memory (ROM) (134), and a hard disk drive (HDD) (136) memory. Many other types of memory may be employed, and the present specification contemplates the use of many varying type(s) of memory in the data storage device (130) as may suit a particular application of the principles described herein. In certain examples, different types of memory in the data storage device (130) may be used for different data storage needs. For example, in certain examples the processor (120) may boot from ROM (134), maintain nonvolatile storage in the HDD (136) memory, and execute program code stored in RAM (132).

Generally, the data storage (130) may comprise a computer readable storage medium. For example, the data storage (130) may be, but is not limited to, an electronic, magnetic, optical, electromagnetic, infrared, or semiconductor system, apparatus, or device, or any suitable combination of the foregoing. More specific examples of the computer readable storage medium may include, for example, the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device such as, for example, the processor (120). The computer readable storage medium does not include transmission media, such as an electronic signal per se.

The peripheral device adapters (135) and network adapter (140) in the computing device (105) enable the processor (120) to interface with various other hardware elements, external and internal to the computing device (105). For example, peripheral device adapters (135) may provide an interface to input/output devices, such as, for example, output device (150), to create a user interface and/or access external sources of memory storage, such as, for example, external data storage (145). As will be discussed below, an output device (150), along with corresponding user input devices such as a keyboard and pointing device, may be provided to allow a user to interact with computing device (105) in order to sort data or records received from a data source.

Peripheral device adapters (135) may also create an interface between the processor (120) and a printer (145) or other media output device. For example, where the computing device (105) groups data or records, and the user then wishes to print the grouped data or records or any other output data resulting form the aggregation of the data, the computing device (105) may instruct the printer (145) to create one or more physical copies of the sorted data or records. A network adapter (140) may additionally provide an interface to the network (115), thereby enabling the transmission of data or records to, and receipt of the data or records from, other devices on the network (120), including the database (110). In one example, the network (115) may comprise two or more computing devices communicatively coupled. For example, the network (115) may include a local area network (LAN), a wide area network (WAN), a virtual private network (VPN), and the Internet, among others.

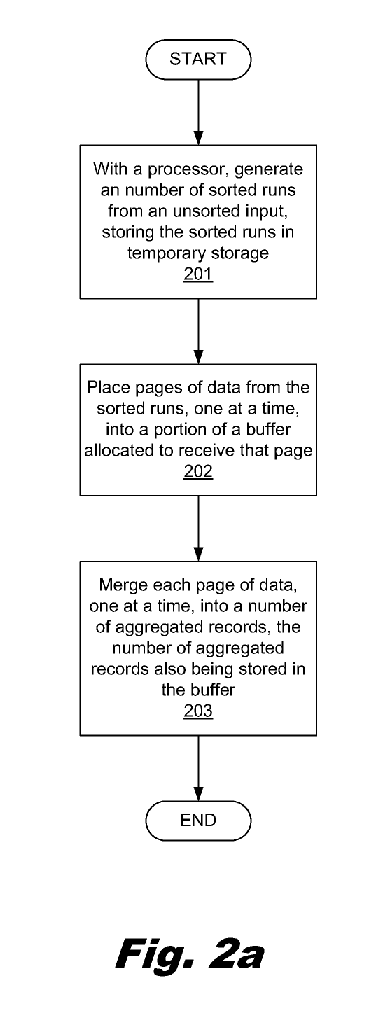

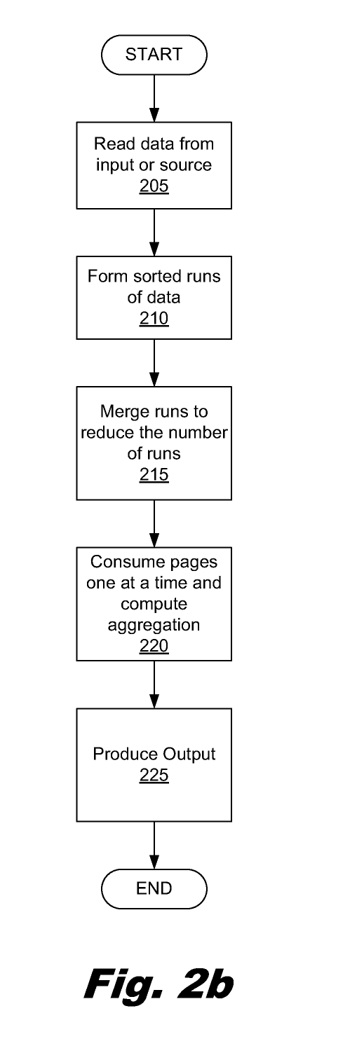

FIG. 2a is a flowchart showing a method of grouping data according to one example of the principles described herein. A processor is used to generate (Bock 201) a number of sorted runs from an unsorted input and storing the sorted runs in temporary storage. As mentioned previously, the computing device (FIG. 1, 105) comprises a data storage device (130) onto which the sorted runs may be stored (Block 201) temporarily.

After the runs have been generated (Bock 201), the pages of data are placed (Block 202), one at a time, into a portion of the buffer (FIG. 1, 125) that has been allocated to receive that page. As briefly mentioned above a page of data may be any amount of data and this amount may be placed in a portion of the buffer (FIG. 1, 125) for which it was allocated. As will be discussed in more detail later, the remaining portions of the buffer that are available may be allocated for temporarily storing a number of aggregated records. Allocating the portions of the buffer (FIG. 1, 125) in this way provides for faster consumption of the individual pages of sorted data than would otherwise have been realized using either an indexed based sorting algorithm, a merge sort algorithm, or hash partitioning algorithm.

Once a page of sorted data form the temporary storage has been placed (Block 202) in the buffer, the page of data is merged (Block 203) into a number of aggregated records. As mentioned, these records are stored in a portion the buffer (FIG. 1, 125) for more efficient aggregation. As one page of data is merged (Block 203) completely, a new page of data from the temporary storage is placed (Block 202) in the buffer, upon which that page is merged (Block 203) into a number of aggregation records as well. This process may continue one page at a time, until all pages within the runs located on the temporary storage are consumed and merged into aggregation records.

FIG. 2b is a flowchart showing an example of a method for grouping data according to another example of the principles described herein. Because the amount of data within a database (FIG. 1, 10) may be large or small and may be in a sorted state or in an unsorted state, any of the details regarding this method described here can be varied or rearranged on a case by case basis. In a first example, the database (FIG. 1, 110) is assumed to contain a data table which is unsorted, non-indexed, with practically no duplicate key values, with uniform or non-skewed key value distributions, and with pages of data holding multiple records.

In the following examples, the output temporarily saved in the buffer (FIG. 1, 125) drives the memory allocation and run generation. In the present examples, run generation produces runs of about 2 times the amount of memory available in the buffer (FIG. 1, 125).

The method starts with the processor (FIG. 1, 120) reading (Block 205) the data from the database (FIG. 1, 110). As briefly described above, the data may be retrieved (205) from database (FIG. 1, 110) and sent to the processor (FIG. 1, 120) which executes code causing the processor (FIG. 1, 120) to implement at least the functionality of aggregating data and removing duplicate records or data. After retrieving the data (Block 205), the processor (FIG. 1, 120) then preprocesses (Block 210) the data. The preprocessing (Block 210) of the input data is accomplished by sorting the data based on a predetermined key value, forming sorted runs based on that key value, and placing those runs on a temporary storage device. In one example, the temporary storage may be a hard disk drive (HDD) (FIG. 1, 136). In other examples, the runs generated during preprocessing (Block 210) may be stored in either random access memory (RAM) (FIG. 1, 132) or read only memory (ROM) (FIG. 1, 134). In one example, sorting (Block 210) of the data may be accomplished by using the quicksort algorithm.

After the input data has been consumed (Block 205) and preprocessed (Block 210) by the processor (FIG. 1, 125), the individual sorted pages of data may then be merged (Block 215) so as to produce less runs held within the temporary storage such as the hard disk drive (HDD) (FIG. 1, 136). Merging the runs (Block 215) in order to form fewer runs within the temporary storage may provide for faster consumption and aggregation of the individual records within the pages of runs and, therefore, may increase the effectiveness of the method.

After the runs have been merged (Block 215) together, one page at a time may be added to the buffer (Block 220) for consumption and aggregation by the processor (FIG. 1, 125). Specifically, a single page of sorted data from a run may be analyzed and the individual records may be taken from the page being analyzed and aggregated into their respective aggregation records (Block 220) in the buffer. Therefore, only a single page of data from the input may be present in the buffer (FIG. 1, 125) while the remaining memory in the buffer is allocated for the aggregated records being generated. Once the individual records have been read (Block 205) and aggregated (Block 220) as described above, any completely aggregated records may be produced as output (Block 225).

As will be described in more detail below, because the input has been sorted (Block 210), while the processor (FIG. 1, 125) is consuming and aggregating pages of data (Block 215) one at a time, the processor (FIG. 1, 125) may determine which aggregated records have been fully aggregated. In one example, when this has been verified, the single aggregated record may be sent to output (Block 225). However, if the aggregation records are to be produced a page at a time, that aggregated record will be temporarily stored in the buffer until a page full of completely aggregated records has been ascertained, upon which the whole page will be expelled from the buffer and sent to output (Block 225).

When the aggregated record within the buffer having highest key value has a key value smaller than the lowest key value in all the pages left to be consumed then that aggregated record within the buffer has been fully aggregated and no other records are available to add to the aggregation record. Additionally, not only is that aggregated record fully aggregated, every record having a key value smaller than that aggregated record is also fully aggregated.

Before the aggregated records are produced as output, the processor may perform additional operations on these newly aggregated records as dictated by the user query. In one example, if the aggregated records each comprised a total sum of salary of all members of a department within an organization, once the aggregated data record reflects the total sum of employees per department, the processor may further be directed to divide the total salary sum by the number of employees within that department before sending that information as output. As a result, an average salary may be computed using this method as well. Various other operations may also be implemented after the processor has determined that no other records exist which need to be added to the aggregate record.

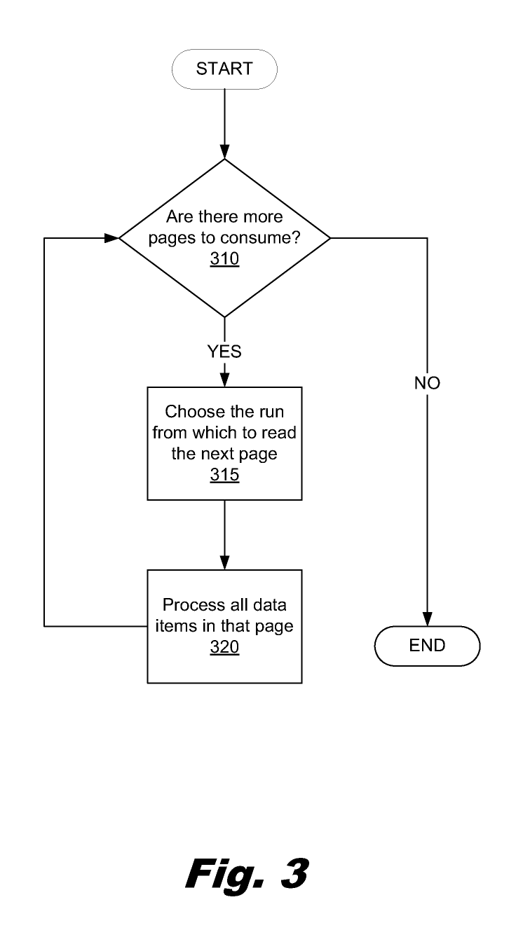

Turning to FIG. 3, a flowchart describing the method of consuming runs and computing aggregation data, as briefly described in FIG. 2, is shown, according to one example of the principles described herein. As briefly mentioned above, each page from each run in the temporary storage device will be consumed and aggregated (FIG. 2, 220). However, after a page has been completely consumed, a decision is made as to whether there are more pages to consume (Block 310). If there are no more pages to consume (Block 310, Determination NO), then the process ends and all data records within the initial input file have been read (FIG. 2, Block 205), sorted (FIG. 2, Block 210), merged (FIG. 2, Block 215), consumed and aggregated (FIG. 2, Block 220), and produced as output FIG. 2, Block 225). However, when it is determined that not all of the pages within the runs located on the temporary storage device have been consumed (Block 310, Determination YES), then the processor (FIG. 1, 125) will choose (Block 315) the next single page from which to read.

Choice of a second or subsequent page to be consumed may be dictated by a priority queue. In one example, the next page to be consumed may be dependent on which page contains a first record in that page having the lowest key value out of all first records of all remaining pages.

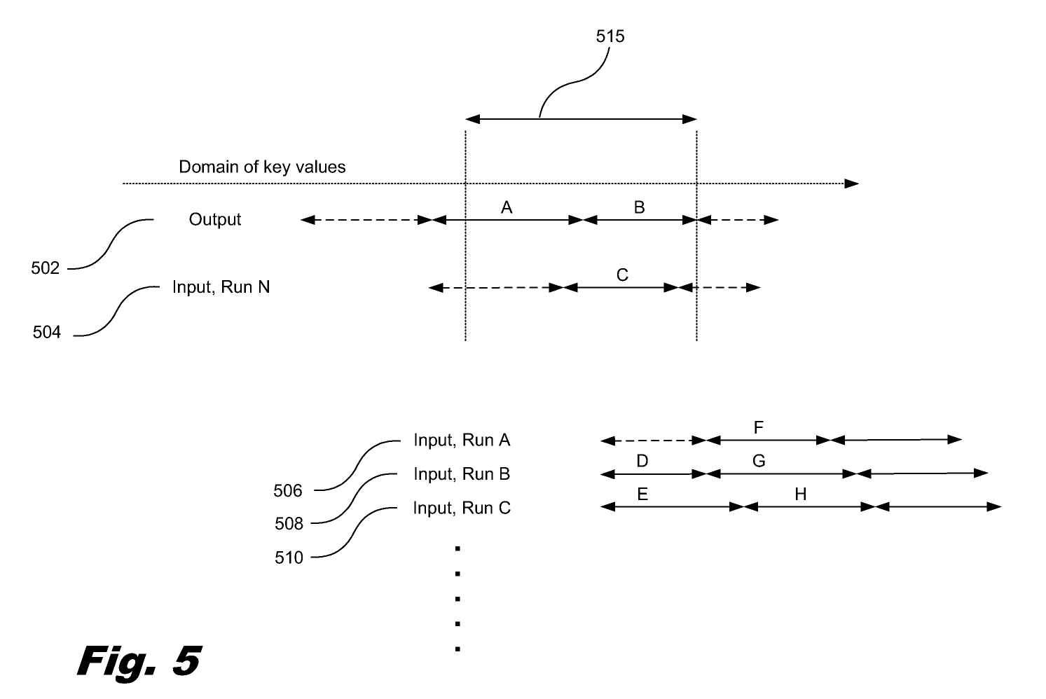

Additionally, as will be described later in connection with FIG. 5, during the process of consuming and aggregating pages of input (FIG. 2, 220) the buffer (FIG. 1, 125) holds a key range of partially and occasionally fully aggregated output records. The key range of data contained at any one given time within the buffer (FIG. 1, 125) may be called the immediate key range. If the key value of a record from a page within the input falls within the immediate key range, that page may be eligible for immediate aggregation based on that predetermined key value.

Although the final output may be much larger than the available memory in the buffer (FIG. 1, 125), the scheduling of the read operations in runs may focus on using the minimal buffer allocation for pages of the input. The buffer (FIG. 1, 125) may increase its memory allocation as needed in order to process pages from the input one at a time and generate aggregation records based on the individual records within those pages. The buffer may also shrink as quickly as possible and sequence pages from the input for minimal memory usage.

In one example, the minimal memory allocation in the buffer for the input may be only one page for an individual run of the input; the algorithm directing the processor (FIG. 1, 125) to consume a single page of input data at a time. The maximum memory allocation for the buffer depends on the key value distributions in the output, for example, distribution skew and duplication skew. Therefore, as discussed above, the buffer allocates enough memory for a single page of data at a time while the rest of the memory within the buffer is allocated for the individual aggregation records being generated.

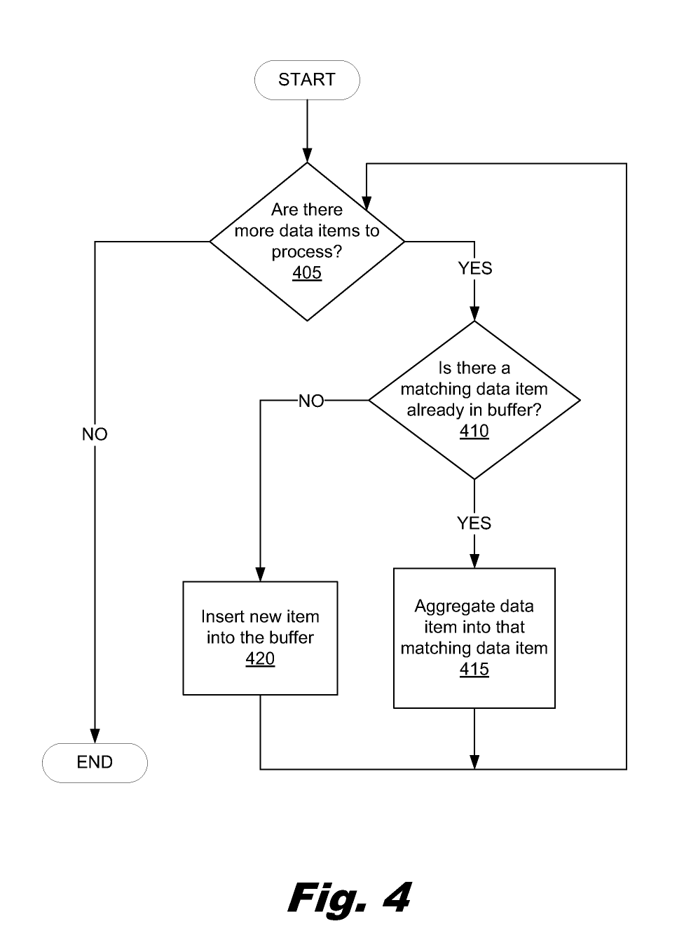

Turing now to FIG. 4, a flowchart describing the method of processing data within a single page as briefly described in FIG. 3 is shown, according to one example of the principles described herein. During consumption of the individual pages within the runs located on the temporary storage device, the processor (FIG. 1, 125) may check to see if there are more data items to be processed (Block 405). If there are no more data items to process (Block 405, Determination No), again, the process ends and the processor (FIG. 1, 125) may further check to see if more pages exist (FIG. 3, Block 310). However, when it is determined that there are additional data items within the page to be processed (Block 405, Determination Yes), then a further decision will be made as to whether an aggregation record already exists for that key value or if a new aggregation record needs to be created (Block 410). If the record currently being analyzed contains a key value for which an aggregate record has already been created (Block 410, Determination Yes), that record is aggregated (Block 415) into the already existing and matching aggregation record. However, if the record currently being analyzed does not contain a key value for which an aggregate record exists already (Block 410, Determination No), a new aggregate record is created (Block 420) for that record and placed in sorted order amongst the other aggregation records in the output.

Similar to what was done with the first page of the first run, the individual records of the first page of the second or subsequent run is consumed and aggregated. In some situations, certain key values may not exist yet in the aggregated pages and therefore new aggregation records may need to be formed (Block 420) representing those previously unknown key values. This process continues until all of the pages of each run are consumed.

Turning now to FIG. 5, a diagram depicting output pages (A, B) and a single input run (Run N) within the buffer is shown. Additionally, various runs (506, 508, 510) are present in a temporary storage device and represent those sorted runs generated during preprocessing (FIG. 2, Block 210). Various pages (C, D, E, F, G, H) from various runs (504, 506, 508, 510) contain records having key values that fall within some sub-range of the entire possible domain of key values within the input. Some pages (A, B), which form the output (502), are resident in the buffer (indicated by solid double-ended arrows) where as some pages have already been expelled or have yet to be loaded (indicated by dashed double-ended arrows). Therefore, the pages in the buffer define the immediate key range (515) which is the intersection of key ranges of all runs (A, B) from the output. Some pages of runs (C) from the input are covered by the immediate key range (515), whereas some have already been grouped or cannot be grouped yet. In one example, practically all memory within the buffer is dedicated to the output pages (A, B), while the memory allocated for the input may be merely one page (C).

In FIG. 5, the buffer (FIG. 1, 125) contains 2 pages of output (A, B) and a single page from run N (504) of the input. Here, the processor merges (FIG. 2, Block 220) records from the input page (C) into the output pages (A, B) and aggregates the records based on the predetermined key value. As described earlier in connection with FIG. 2, the entire page (C) is consumed (FIG. 2, Block 220) before a new page (D, E, F, G, H) is placed in the buffer of the buffer (FIG. 1, 125). Therefore, the process continues one page at a time, until all pages in the input data have been consumed. However, once a current input page (C) is consumed, a new page will be chosen to be placed in the buffer (FIG. 1, 125). Again, the page that is chosen next may depend on which page contains the record having the lowest key value of any remaining page. Because the input records were previously sorted (FIG. 2, Block 210), the next page to be consumed will generally be found at the beginning of a run (506, 508, 510) located in temporary storage. Therefore, pages D, E, and F are all possible candidates. Indeed, any next page within any individual run may be the next candidate page to be loaded into the buffer (FIG. 1, 125).

As described earlier, a priority queue will determine which page from which run in temporary storage will be the next to be loaded into the buffer and aggregated (FIG. 2, Block 220). The processor (FIG. 1, 125), implementing this priority queue, will determine for each run which key value has already been processed. This value is known by the processor because the records having these key values now have corresponding aggregation records in the buffer. The processor (FIG. 1, 125) will then determine which run contains the lowest key value that is equal to or greater than the highest key value already processed. The run containing the page having that key value is the next to be placed in the buffer and consumed (FIG. 2, Block 220). Additionally, every aggregated record within the buffer having a key value lower than the lowest key value not yet processed may be omitted from output (FIG. 2, 225).

Thus, as key values are added to the pages in the output (A, B), a number of key values will no longer have any records added to them because of the sorted nature of the individual pages (C, D, E, F, G, H) in the input. By using this priority queue, the domain key range (315) may move from the lowest key value to the highest key value. As the immediate key range moves through the domain of key values, the immediate key range may expand and shrink due to the priority queue determining which key values to send to output.

The principles and methods described above may also be accomplished by a computer program product comprising a computer readable storage medium having computer usable program code embodied therewith that, when executed, performs the above methods. Specifically, computer usable program code may instruct a processor (FIG. 1, 120) to read (FIG. 2, Block 205) a data table or some data from a database (FIG. 1, 110) and determine (FIG. 2, Block 210) whether that data has bee preprocessed or sorted. If the input data has not been preprocessed or sorted, the computer usable program code may direct a processor (FIG. 1, 120) to sort that data in preparation for grouping it more efficiently. Therefore, the computer usable program code may instruct a processor to generate (FIG. 2a, 201) a number of sorted runs from an unsorted input and store the sorted runs in temporary storage. The computer usable program code may also direct the processor (FIG. 1, 120) to begin to place (FIG. 2a, Block 201) pages of data, one at a time, from the temporary storage into a portion of a buffer (FIG. 1, 125) allocated to receive that page. The computer usable program code may further direct the processor (FIG. 1, 120) to merge (FIG. 2a, 203) each page of data, one at a time, into a number of aggregated record, the number of aggregated records also being stored in the buffer (FIG. 1, 125). As described above, these aggregated records will be held in the buffer (FIG. 1, 125) temporarily until the runs are no longer part of the immediate key range within the domain of key range values being grouped. The computer usable program code may then direct the processor (FIG. 1, 120) to omit these runs from the buffer (FIG. 1, 120) and write them to a data storage device (130) for later review or implementation by a user.

The preceding specification and figures describe a computer executed method for grouping data. The method described replaces the standard methods of grouping such as merge sort, hash partitioning, and indexed based grouping with a single method, thereby eliminating the need for a compile-time choice amongst these methods in exchange for a method that always performs at least as well as the previously mentioned methods. This method and device for grouping data may have a number of advantages, including: adaptability to small and large inputs, small and large reduction factors (i.e. the quotient of input size and output size), and sorted output. The method can be adapted to fluctuating memory contention and memory allocation. Still further, the above described method may be implemented concurrently in a similar fashion with two sets of inputs to be joined thereby allowing one or both of the inputs to grouped while both inputs are being joined into one data set.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A computer-executed method for grouping data comprising:
with a processor, generating a number of sorted runs from an unsorted input, storing the sorted runs in temporary storage;
placing pages of data from the sorted runs, one at a time, into a portion of a buffer allocated to receive that page; and
from the allocated portion of the buffer, merging each page of data, one at a time, into a number of aggregated records, the number of aggregated records also being stored in the buffer.

2. The method of claim 1, further comprising using a priority queue to determine when the aggregated records are to be finalized as output records.

3. The method of claim 2, in which the priority queue:
determines which records have already been aggregated from each sorted run in temporary storage, the records each containing a key value;
determines which runs contain a page comprising records having the highest key value already aggregated as its lowest key value; and
selects a page comprising records having the highest key value already aggregated as its lowest key value as the next page to be merged.

4. The method of claim 2, in which the priority queue determines which records are records to be output from the buffer by determining which record within the number of sorted runs comprises a key value being the lowest key value amongst all records within the number of sorted runs and output from the buffer any records having a key value less than the lowest key value within the sorted runs.

5. The method of claim 1, further comprising, with the processor, merging together a number of runs located in temporary storage before the processor merges a page of data into a number of aggregated records.

6. The method of claim 1, further comprising deleting duplicate records within the pages of data while merging each page of data into a number of aggregated records.

7. A system for grouping data comprising:
a processor programmed to:
generate a number of sorted runs from an unsorted input, storing the sorted runs in temporary storage;
place pages of data from the sorted runs, one at a time, into a portion of a buffer allocated to receive that page; and
from the allocated portion of the buffer, merging each page of data, one at a time, into a number of aggregated records, the number of aggregated records also being stored in the buffer.

8. The system of claim 7, in which a priority queue determines when the aggregated records can be finalized as output.

9. The system of claim 8, in which the priority queue
determines which records have already been aggregated from each sorted run in temporary storage, the records each containing a key value;
determines which runs contain a page comprising records having the highest key value already aggregated as its lowest key value; and
selects a page comprising records having the highest key value already aggregated as its lowest key value as the next page to be merged.

10. The system of claim 8, in which the priority queue determines which records are to be records to be output from the buffer by determining which record within the number of sorted records comprises a key value being the lowest key value amongst all records within the number of sorted runs and output from the buffer any records having a key value less than the lowest key value within the sorted runs.

11. The system of claim 7, in which the processor merges together a number of runs located in temporary storage before the processor merges a page of data into a number of aggregated records.

12. The system of claim 7, in which the processor deletes duplicate records within the pages of data while merging each page of data into a number of aggregated records.

13. A computer program product for grouping data, the computer program product comprising:
a computer readable storage medium having computer usable program code embodied therewith, the computer usable program code comprising:
computer usable program code that instructs a processor to generate a number of sorted runs from an unsorted input, storing the sorted runs in temporary storage;
computer usable program code that instructs a processor to place pages of data from the sorted runs, one at a time, into a portion of a buffer allocated to receive that page; and
computer usable program code that instructs a processor to, from the allocated portion of the buffer, merge each page of data, one at a time, into a number of aggregated records, the number of aggregated records also being stored in the buffer.

14. The computer program product of claim 13, further comprising computer usable program code that instructs a processor to implement a priority queue to determine when the aggregated records are to be finalized as output records.

15. The computer program product of claim 14, in which the priority queue:
determines which records have already been aggregated from each sorted run in temporary storage, the records each containing a key value;
determines which runs contain a page comprising records having the highest key value already aggregated as its lowest key value; and
selects a page comprising records having the highest key value already aggregated as its lowest key value as the next page to be merged.
